(19) United States
(12) Patent Application Publication
(10) Pub. No.: US 2005/0285290 A1
(43) Pub. Date: Dec. 29, 2005

(54) Method of manufacturing an organic/inorganic hybrid porous material

(75) Inventor: Kazuki Nakanishi, Kyoto-shi (JP)

Correspondence Address: KANESAKA BERNER AND PARTNERS LLP, SUITE 300, 1700 DIAGONAL RD, ALEXANDRIA, VA, 22314-2848, US

(73) Assignee: KYOTO MONOTECH CO., LTD., Kyoto-shi (JP)

(21) Appl. No.: 11/188,699

(22) Filed: Jul. 26, 2005

(30) Foreign Application Priority Data
Mar. 31, 2004 (JP) 2004-102654

(51) Int. Cl. B29C 67/20

(52) U.S. Cl. 264/42

(57) ABSTRACT

In a method of manufacturing an organic/inorganic hybrid porous material containing both mesopores and macropores, a homogenous solution is prepared where a water-soluble polymer or amphipathic material as a phase separation induction element is dissolved in an aqueous solution containing sol-gel reaction catalyst elements, and a continuous 3-dimensional mesh-structured gel including a solvent-rich phase is formed. The gel is immersed in an aqueous solution containing a compound generating ammonia via hydrolysis and curing under hydrothermal conditions by heating in a closed state to form macropores by drying the gel and to evaporate the solvent from the solvent rich phase. Mesopores is formed in the skeletal phase by removing the phase separation induction elements from the gel after drying via thermolysis or extraction.

### BACKGROUND OF THE INVENTION

1. Field of the Invention

The present invention relates to a method of manufacturing an organic/inorganic hybrid porous material, specifically a purely organic polysilsesquioxane separation medium. The porous material produced by this method can be used as chromatography fillers, porous material for blood separation, porous material for absorbents, porous material for low molecular weight polymer absorption of odors as well as porous material for enzyme carriers and catalyst carriers. Further, the microprocessed liquid path produced with the method of the present invention is well suited for microspatial chemical reaction devices.

2. Description of the Background

In addition to forms such as those for granular filler and integrated units, the inorganic and organic hybrid material currently used in the applications noted above is either pure silica or a product containing a silica-polysiloxane composition where part of the silica is replaced by an organic/inorganic hybrid containing a polysiloxane bond. In general, the surface of the material is utilized unchanged or modified by various functional groups. While it is possible to partially use other metallic oxides and organic hydrocarbon polymers not containing any metallic elements, silica and silica-polysiloxane compounds are currently the standard material used. See Kokai H5-140313. When using this conventional material as a liquid chromatography separation medium, the pore capacity of typical pores (mesopores) greater than 5 nm on the surface or interior of granular materials or on the surface or interior of the solid portion (skeletal portion) of integrated materials should be greater than 0.1 cm³/g. With silica or silica-polysiloxane materials, production of the mesopores necessary for the separation medium are typically obtained by a polymer reaction. The silica-containing solvent and the silica-polysiloxane gel are brought into contact with a basic solution and are subjected to hydrothermal treatment by raising the temperature and pressure under closed conditions in the presence of water.

Mesopore formation with this conventional process is problematic when materials with greater than 50% silica are used as the starting composition. In particular, it is difficult to obtain a narrow distribution of pore diameters and adequate pore capacity needed for highly efficient separation even when mesopores are formed. Also, when silica or silica-polysiloxane materials are used for separations in biochemical fields requiring strong basic conditions, specifically, a pH greater than 10, the materials actually dissolve and decay, making separation impossible. On the other hand, organic polysilsesquioxane not containing any inorganic matter is subject to much less dissolution under strong basic conditions, and even at a pH of about 12, there is enough chemical resistance to enable good separation.

Thus, a need exists for a method of manufacturing an inorganic/inorganic hybrid porous material containing both mesopores and macropores, which overcomes the above disadvantages.

### SUMMARY OF THE INVENTION

The present invention is based on the discovery of an organic/inorganic hybrid composition, specifically an organic polysilsesquioxane composition not containing any inorganic silica as starting material, and a method of manufacturing the same.

In more detail, the present invention provides a method of manufacturing an organic/inorganic porous hybrid material containing both mesopores and macropores, which entails:
a) preparing a homogenous solution where a water-soluble polymer or amphipathic material as a phase separation induction element is dissolved in an aqueous solution containing sol-gel reaction catalyst elements;
b) forming a continuous 3-dimensional mesh-structured gel containing a solvent-rich phase, wherein a low molecular weight polymer compound containing both a non-hydrolyzed organic functional group and a hydrolyzed functional group is added to the homogenous solution for a sol-gel reaction, and a skeletal phase with an organic/inorganic hybrid polymer of the low molecular weight polymer compound from the sol-gel reaction affixed to the surface of the phase separation induction element containing the water-soluble polymer or amphipathic material;
c) immersing the gel in an aqueous solution containing a compound generating ammonia via hydrolysis and curing under hydrothermal conditions by heating in a closed state,
d) forming macropores by drying the gel and evaporating the solvent from the solvent rich phase; and
e) forming mesopores in said skeletal phase by removing the phase separation induction elements from the gel after drying by thermolysis or extraction.

### BRIEF DESCRIPTION OF THE DRAWINGS

FIG. 1 is a scanning electron microscope photograph of the structure obtained via evaporation of the solvent after the sol-gel reaction process for Example 1.

FIG. 2 shows the pore distribution of the porous material obtained in Example 1 using the mercury pressure method.

FIG. 3 shows the pore distribution of the porous material obtained in Example 1 using the nitrogen adsorption method.

FIG. 4 shows the pore distribution of the porous material obtained in Example 1 using the nitrogen adsorption method.

FIG. 5 shows the pore distribution of the porous material obtained in Example 1 using the nitrogen adsorption method.

FIG. 6 is the chromatograph of the unmodified surface column obtained in Example 1.

FIG. 7 is the chromatograph of the surface column modified using octadecylsilyl obtained in Example 1.

### DETAILED DESCRIPTION OF THE PREFERRED EMBODIMENT

The present invention relates to an organic/inorganic hybrid composition, specifically an organic polysilsesquioxane composition containing no inorganic silica as a starting material. The present invention is based on the discovery of starting materials where phase separation and sol-gel transition occurs simultaneously for a narrow distribution of macropores, which forms mesopores suitable for a separation medium by curing based on hydrothermal treatment. Using these starting materials, a gel is produced under conditions where phase separation and sol-gel transition occur simultaneously so there are macropores with a narrow distribution of pore diameters, mesopores suitable for use as a separation medium and a means to produce porous material suitable for an integrated separation medium.

The objective of the present invention is to provide a method of manufacturing porous materials applicable as a separation medium that contain an organic/inorganic hybrid composition where no inorganic elements are included and all of the silicon atoms have at least one silicon-carbon bond, specifically an organic polysilsesquioxane or an organic/inorganic hybrid composition containing fewer silica-oxygen bonds where the average composition is (R(1+x)SiO(3−x)/2)n, where R is an organic functional group and x=0˜1.

The present inventors have met these objectives with the production of an organic/inorganic hybrid composition, specifically an organic polysilsesquioxane porous material with the sol-gel method by conducting hydrothermal treatment necessary for mesopore formation after gelation. The present invention includes each of the following processes, and presents a manufacturing method for organic/inorganic hybrid porous material with macropores added to mesopores: (i) a process of preparing a homogenous solution where a water-soluble polymer, such as sodium sulfonated polystyrene (Mn=50,000) and polyethylene oxide (Mn=10,000) or amphipathic material, such as poly(ethylene glycol)-poly(propylene glycol)-poly(ethylene glycol)-triblock copolymer, as the phase separation induction element is dissolved in an aqueous solution containing sol-gel reaction catalyst elements; (ii) a process of forming a continuous 3-dimensional mesh-structured gel containing a solvent rich phase wherein a low polymer compound containing both a non-hydrolyzed organic functional group and a hydrolyzed functional group is added to the homogenous solution for a sol-gel reaction, and a skeletal phase with an organic/inorganic hybrid polymer of the low polymer compound from the sol-gel reaction affixed to the surface of the phase separation induction element containing the water-soluble polymer or amphipathic material; (iii) a process of immersing the gel in an aqueous solution containing a compound generating ammonia via hydrolysis and curing under hydrothermal conditions by heating in a closed state; (iv) a process of forming macropores by drying the gel and evaporating the solvent from the solvent rich phase, and (v) a process of forming mesopores in the skeletal phase by removing the phase separation inductive elements from the gel after drying via thermolysis or extraction. Here, the low polymer compound is a material with no more than 50% silica.

Further, there is a specific manufacturing method provided, which entails: (i) a process of preparing a homogenous solution where water-soluble polymer or amphipathic material as the phase separation induction element is dissolved in an aqueous solution containing sol-gel reaction catalyst elements; (ii) a process of forming a continuous 3-dimensional mesh-structured gel containing a solvent rich phase wherein a modified organic silane low molecular weight polymer compound containing a hydrolyzed functional group is added to the homogenous solution for a sol-gel reaction, and a skeletal phase with an organic polysilsesquioxane polymer created from the aforementioned-modified organic silane low molecular weight polymer compound from the sol-gel reaction affixed to the surface of the die elements containing the aforementioned water-soluble polymer or amphipathic material; (iii) a process of immersing the aforementioned gel in an aqueous solution such as urea containing a compound generating ammonia via hydrolysis and curing under hydrothermal conditions by heating in a closed state; (iv) a process of forming macropores by drying the aforementioned gel and evaporating the solvent from the solvent rich phase, and (v) a process of forming mesopores in the skeletal phase by removing the aforementioned die elements from the gel after drying via thermolysis or extraction.

Generally, the inorganic porous material such as silica gel and the organic/inorganic hybrid porous material such as polysiloxane are produced with the liquid phase reaction of the sol-gel method. The sol-gel method is well-known and involves using an inorganic low molecular weight polymer (generally, low or high molecular weight polymer is determined by molecular weight of 10,000) compound with a hydrolyzed functional group or a low polymer compound containing both a non-hydrolyzed organic functional group and a hydrolyzed functional group as the starting material.

This is a general method which may be used to obtain an oxide or organic/inorganic hybrid composition aggregate or polymer from an inorganic low molecular weight polymer compound or a low polymer compound containing both a non-hydrolyzed organic functional group and a hydrolyzed functional group via the sol-gel reaction, specifically the hydrolysis and the subsequent polymer reaction (polycondensation). Metallic alkoxide is the best known low molecular weight polymer starting material, but other examples include metallic chloride, metallic salts or coordination compounds with hydrolyzed functional groups such as carboxyl groups or β-diketones as well as metallic amines.

When manufacturing organic polysilsesquioxane porous material using the sol-gel method, the features of the manufacturing method for the organic/inorganic hybrid porous material of the present invention, such as the organic polysilsesquioxane porous material, in the presence of both phase separation inductive elements such as a water soluble polymer or amphipathic material, the reaction conditions are modified by causing sol-gel transition and phase separation simultaneously, and include the solvent rich phase forming macropores with the subsequent drying process and the skeletal phase to form interior mesopores by the subsequent thermolysis process. Existing organic polysilsesquioxane porous material only controls the macropores in the macrometer range while basically ignoring mesopores. This is because with existing methods, there has been no known mesopore production process involving a gel containing a chemical structure with low equilibrium solubility in a basic solution such as organic polysilsesquioxane. Here, the low polymer compound containing both a non-hydrolyzed organic functional group and a hydrolyzed functional group can be silicon alcoxide low molecular weight polymers containing methyl trimethoxysilane, ethyl trimethoxysilane, vinyl trimethoxysilane, γ-glycidoxy propyl trimethoxysilane, γ-glycidoxy propyl trimethoxysilane, β-(3,4 epoxycyclohexyl)ethyl trimethoxysilane, N-β(amino ethyl) γ-aminopropyl trimethoxysilane, N-β (aminoethyl) γ-amino propyl trietoxysilane, γ-methacryloxy propyl trimethoxysilane, γ-amino propyl trietoxysilane, γ-amino propyl trimethoxysilane, 3-acryloxy propyl trimethoxysilane and at least one silicon-carbon bond, or a compound (such as a bis-trialkoxy xylylalkane) where at least one carbon is linked with at least two silicon atoms, but is not limited to these. With a gel obtained via mixing and hydrolyzing an organic metallic compound containing a non-hydrolyzed organic functional group and a hydrolyzed functional group by bonding at least one metal-carbon bond, the non-hydrolyzed organic functional group also bonds via a metal-carbon bond after gelling, which enhances the alkaline resistance of the entire gel.

Theoretically, the elements to be added for inducing phase separation are aqueous polymers created with an appropriate concentration of the aqueous solution and which are uniformly dissolved in the reactant containing alcohol generated by hydrolysis of the hydrolyzed functional group contained in the starting material of the sol-gel reaction. Specific examples that are suitable include sodium chloride or calcium chloride of polystyrene sulfonic acid, i.e., that is a polymer metallic salt, polyanion from the disassociation of the polymeric acid polyacrylic acid, a basic polymer polyaryl amine or polyethylene imine generated by a polycation in a solution, a neutral polymer polyethylene oxide with an ether bond as the principal chain and polyvinyl pyrrolidone with a carbonyl group on the other chain. Also, it is acceptable to employ formaldehyde, polyvalent alcohol and surfactants instead of an organic polymer. In that case, it is appropriate to use glycerin as the polyvalent alcohol, a cationic surfactant such as halogenated alkyl trimethyl ammonium as the surfactant, polyoxyethylene alkyl ether as the nonionic surfactant and poly(ethylene glycol)-poly(propylene glycol)-poly(ethylene glycol) tri block copolymer as the amphipathic material, but is not limited to these as long as the compound can induce phase separation during the sol-gel reaction.

The terms “macropore” and “mesopore” employed in the present invention are defined according to standard IUPAC guidelines. Macropore refers to pores with diameters greater than 50 nm while mesopore refers to pores between macropores and minipores (diameters less than 2 nm), specifically those with diameters 2˜50 nm. In general, the porous material in the present invention has a narrow distribution of pore diameters, specifically mesopores in the 2˜10 nm range.

The theory of the present invention is as previously stated above in the background section, and involves the sol-gel method and can apply to all types of organic/inorganic hybrid compounds obtained by creating polymers containing polysiloxane bonds from low polymers. The particular application of the method of the present invention forms a porous material when the organic/inorganic hybrid polymer is an organic polysilsesquioxane polymer. To produce the porous material that contains both macropores and mesopores from the organic polysilsesquioxane polymer according to the present invention, the sol-gel reaction process is conducted under acidic conditions for at least the initial reaction, and the amount of water containing the catalyst for the aforementioned sol-gel reaction must be in the range of 1.0˜50.0 g per 0.0167 mol of silicon atoms (1.0 g reduced silica anhydride weight) to control the reaction conditions. This allows the sol-gel transition and phase separation to occur simultaneously to generate a gel containing both a solvent rich phase and a skeletal phase.

According to this description, when producing porous material with organic polysilsesquioxane as the primary ingredient using a sol-gel reaction, regardless of whether the catalyst is acidic, neutral or basic, existing methods produce a solid with a three-dimensional gel mesh. However, the present invention produces the gel by separating the solvent rich phase and the skeletal phase, which requires a reaction under simple acidic conditions to induce homogeneous hydrolysis and gel formation. Alternatively, with a homogeneous reaction from inside the reaction solution, the acidity at the beginning of the reaction gradually changes to basic (for example, by adding urea to the reaction solution, the urea gradually generates hydrolyzed ammonia) so homogeneous hydrolysis and gel formation can be induced. The sol-gel reaction involves creating a product with a bonded site due to hydrolysis (polycondensation reaction site; such as hydroxyl) and gel formation by a polycondensation reaction by such bonded sites. Under acidic conditions, there are many polycondensation sites formed due to the hydrolysis reaction, and it is believed and considered plausible that the homogeneous polycondensation reaction (gel formation) is due to these many sites. Therefore, if the beginning of the sol-gel reaction is basic, this promotes the polycondensation reaction and causes uneven gel formation. Catalysts for the sol-gel reaction include mineral acids such as hydrochloric acid, nitric acid and phosphoric acid, organic acids such as acetic acid and citric acid, weak bases such as ammonia and amines, and strong bases such as sodium hydroxide and potassium hydroxide but are not limited to these since the important factor is the regulation of the fluids.

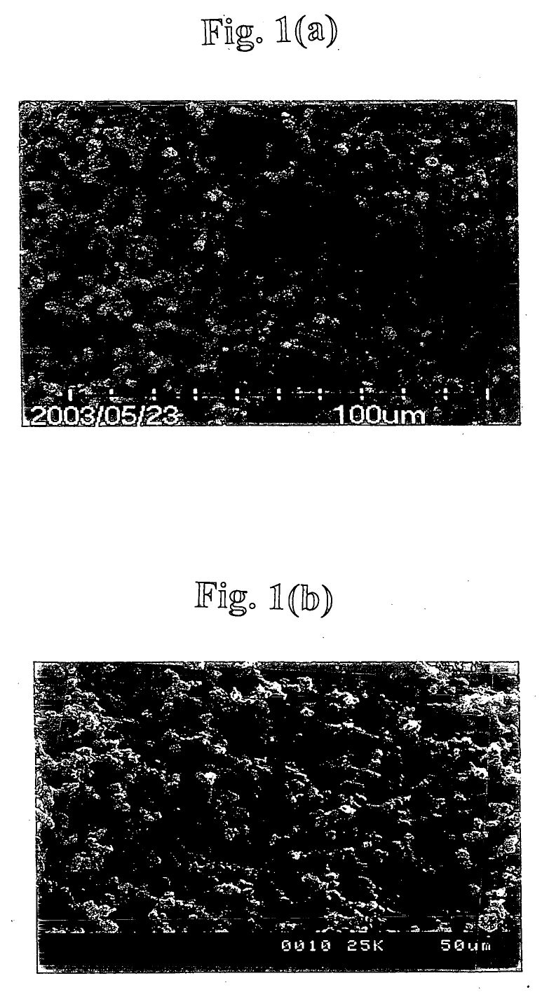

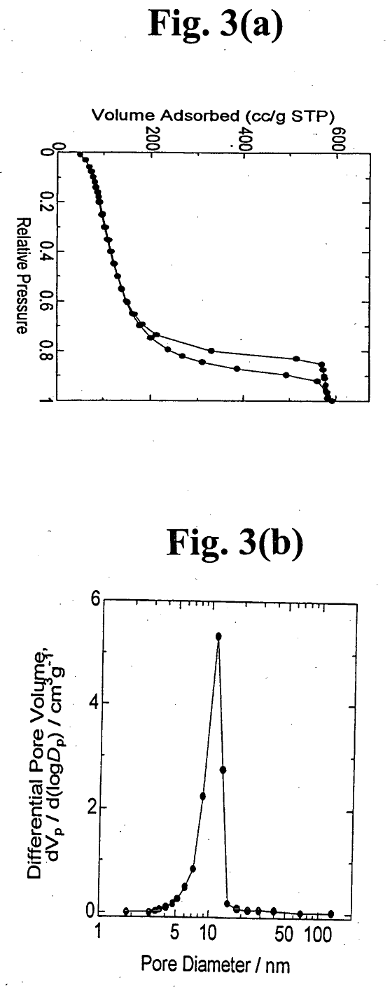

By controlling the sol-gel reaction process that causes sol-gel transition and phase separation simultaneously, the present invention creates a gel with a solvent rich phase with an abundance of solvent (water) and a skeletal phase with an abundance of organic polysilsesquioxane polymer. This causes a cloudy solution that does not settle. This product solidifies when cured slightly (at a slightly increased temperature if necessary) so the target porous material is obtained after drying and subjecting this to thermolysis (or extraction). To produce the organic/inorganic hybrid porous material with both mesopores and macropores using the method in the present invention, first a homogenous solution is prepared where a water-soluble polymer or amphipathic material as the phase separation induction element is dissolved in an aqueous solution containing sol-gel reaction catalyst elements. Next, a low polymer compound containing both a non-hydrolyzed organic functional group and a hydrolyzed functional group is added to said homogenous solution for a sol-gel reaction where a gel is created that is separated into a solvent rich phase and a skeletal phase, as indicated above. The solvent rich phase is a phase with a continuous three-dimensional mesh with diameters corresponding to macropores. As indicated above, the structure can be confirmed by observation using an electron microscope after drying and eliminating the solvent. See FIG. 1. The sketal phase has an abundance of an organic/inorganic hybrid polymer of a low polymer compound containing both a non-hydrolyzed organic functional group and a hydrolyzed functional group from the sol-gel reaction, which is basically a phase that has a continuous three-dimensional mesh structure. This phase forms a product adhered to the amphipathic material or water soluble polymer surface induced by phase separation. If using amphipathic materials and removing the dies (amphipathic compounds), formation of the pores (mesopores) in the skeletal phase can be confirmed. See FIG. 3. The oxide polymer contains a hydroxyl on the surface and has a strong mutual attraction with the proton receptor of the amphipathic material so it is possible to transfer the mesh structure created by the die elements in the solution to the gel mesh. If the mesopore size required by the separation medium obtained from the aforementioned amphipathic material die effect is exceeded, the gel is heated under closed conditions in a solution containing a compound that generates ammonia by hydrolysis or in a basic solution, and by maintaining the thermolytic conditions, it is possible to form mesopores with the desired size via the treatment temperature and time. After solidifying the product of the sol-gel reaction (gel), curing is conducted for a suitable length of time or under thermolytic conditions. Then the solvent is removed by drying to produce macropores that penetrate the space in the solvent rich phase. Next, it is heated to a temperature where the hydrocarbon chain in the gel mesh does not break down and mesopores in the nanometer range can be obtained.

The present invention will now be further illustrated by an Example which is provided solely for purposes of illustration and is not intended to be limitative.

### EXAMPLE 1

(1) Using polyethylene glycol (PEG, average molecular weight 10,000) as the additive for producing the porous material for the network of pores and for phase separation, 0.2 g of PEG was added to 9.353 g of a 0.01 mol acetic acid solution and agitated for 5 minutes to effect dissolution. Then, a uniform solution was obtained by dripping 2 ml of BTME (112-bistrimethoxy silyl ethanol) 0.1M CH₃COOHaq=1:65 (mol ratio) and agitating for 10 minutes. The solution was sealed in a sample vial and left to gel in a container maintained at 60° C., and then 24 hour edging was conducted. The cured gel was removed from the sample vial and then it was immersed for one day each, first in water and then in a 1.5 mol urea solution. After sealing with the urea solution in an autoclave container, it was subject to thermolytic treatment for 24 hours at 150° C. The thermolytic treated gel was removed and then immersed for two hours each, first in water and then in an ethanol solution (30 v %). After being dried for 3 days, thermal treatment was conducted for 5 hours at 350° C.

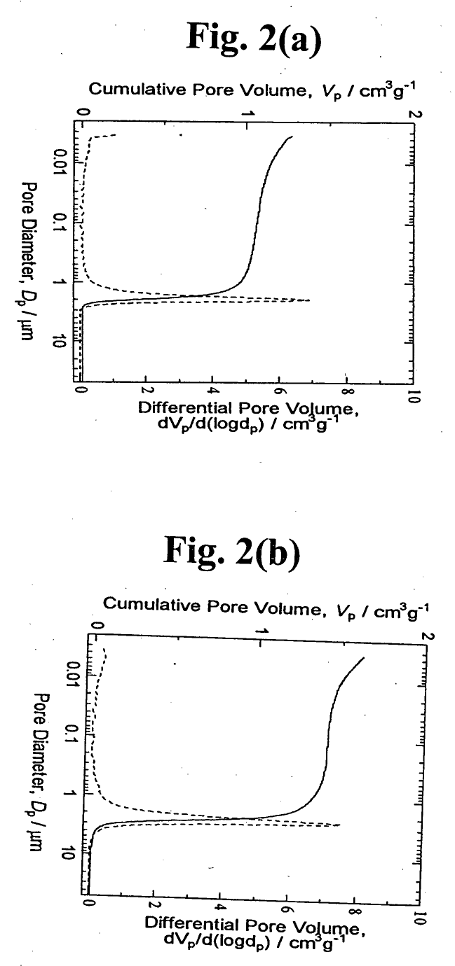

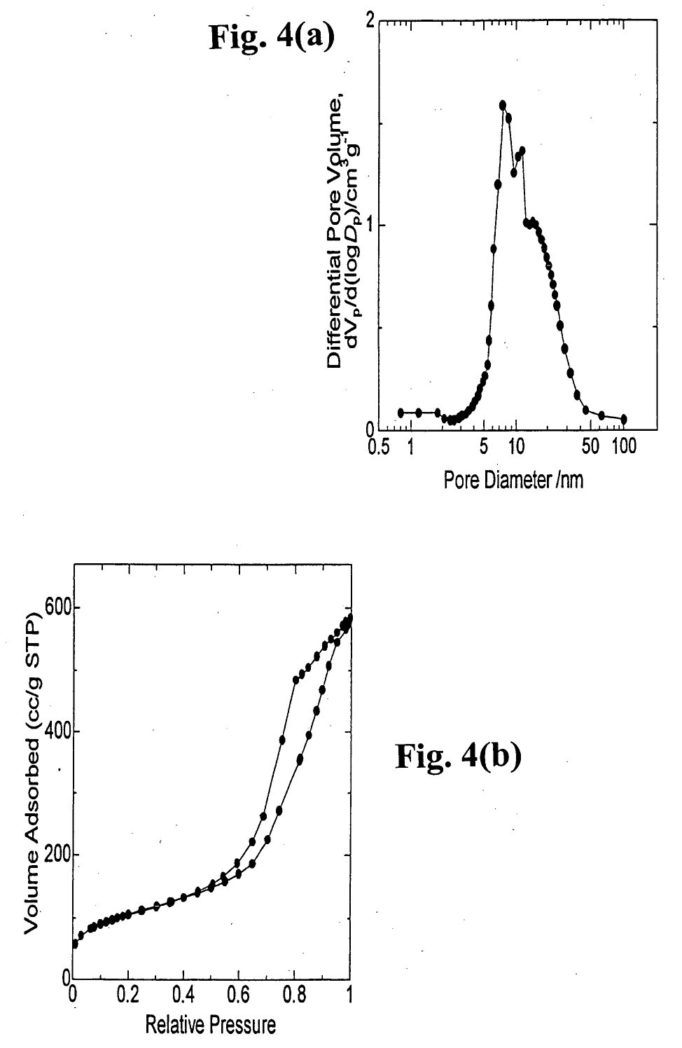

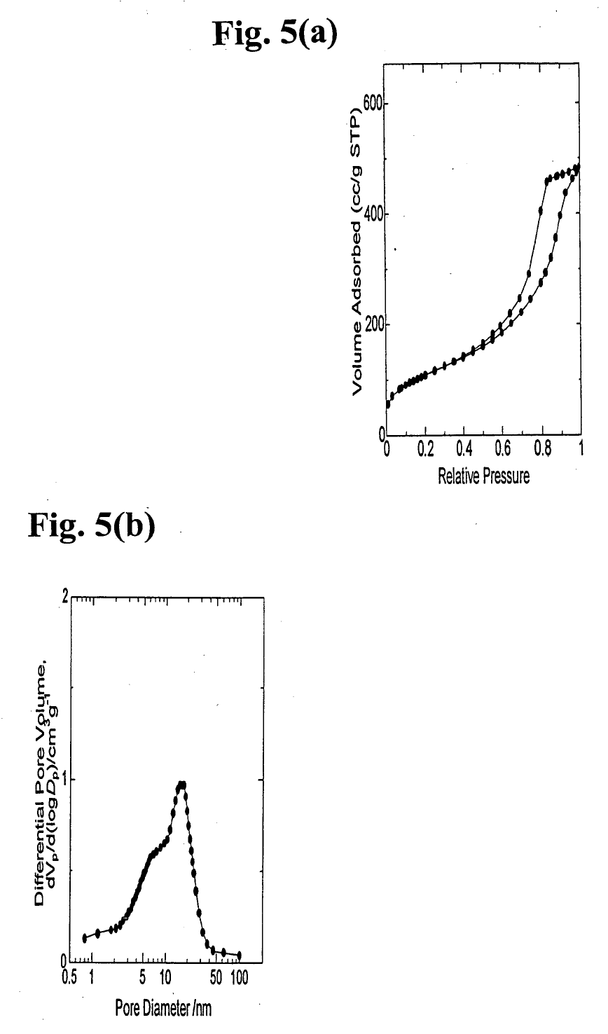

Using poly(ethylene glycol)-poly(propylene glycol)-poly(ethylene glycol) tri block copolymer as the phase separation induction additive, 5.468 g of a 0.1 mol concentrated nitric acid solution and 0.7 g of EOPOEO5800 (average molecular weight of 5,800) were combined and agitated for one hour in a container maintained at 60° C. 2 mL of BTME was mixed in and agitated for 5 minutes to produce BTME:0.1M HNO₃aq=1.38 (mol ratio). The solution was placed in a round glass tube and left to gel in a container maintained at 60° C. and then 24 hour edging was conducted. The cured gel was removed from the tube and then was immersed for one day each, first in water and then in a 1.5 mol urea solution. After sealing in the tube again, it was subject to thermolytic treatment for 24 hours at 150° C. The thermolytic treated gel was removed and then immersed for two hours each, first in water and then in an ethanol solution (30 v %). After being dried for 3 days, thermal treatment was conducted for 5 hours at 350° C. FIG. 1 shows a scanning electron microscope photograph of the structure obtained. (a) shows the results obtained with the gel produced using EOPOEO5800 and (b) with the gel produced using PEG. FIG. 2 shows the pore distribution using the mercury pressure method. (a) shows the results obtained with the gel produced using EOPOEO5800 and (b) with the gel produced using PEG. With either method, it is possible to form macropores with a size appropriate for liquid chromatography. FIG. 3 shows the results of a pure silica gel with mesopores produced from tetra methoxysilane using a chromatography column subject to 4 hours of thermolytic treatment at 110° C. in a urea solution. FIG. 4 is of a gel produced using BTME and EOPOEO5800, and FIG. 5 is of a gel produced using BTME and PEG.

The gel produced with BTME had the optimal skeletal Mesopore formation by chromatography.

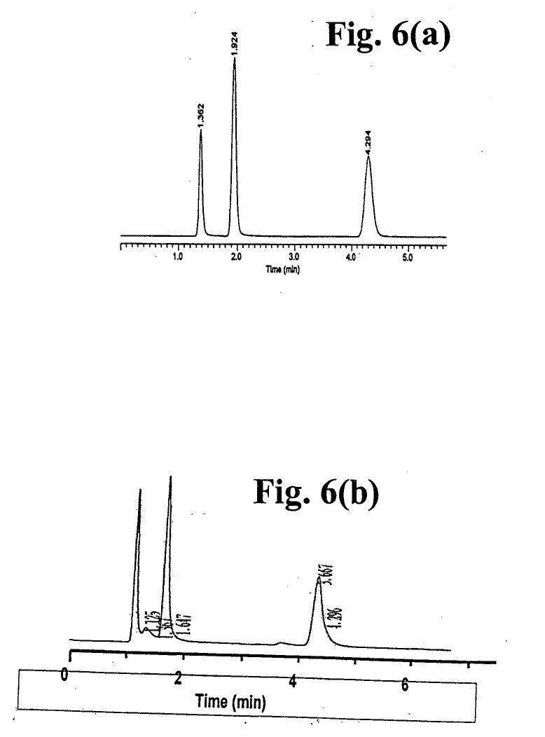

(2) A round gel with a diameter of 4.6 mm and a length of 83 mm was formed using the column method described above in (1) under normal phase conditions. After covering with a thermal shrinkage tube, the surrounding area was solidified with epoxy resin to create a column for liquid chromatography, and then chromatographic evaluations were conducted under normal phase conditions. See FIG. 6. FIG. 6(a) shows the results obtained with a pure silica gel produced from tetra methoxysilane while FIG. 6(b) shows results from a gel produced using BTME and EOPOEO5800. The transition phase used for evaluating was hexane/2-propanol=98/2 (v/v) and the samples used were toluene, dinitrotoluene and dinitrobenzene, from the initial peak. The retention rate for the dinitro toluene and dinitro benzene was nearly identical to that of the pure silica gel column (10 nm mesopore diameter) produced from tetra methoxysilane, and demonstrate similar retentions.

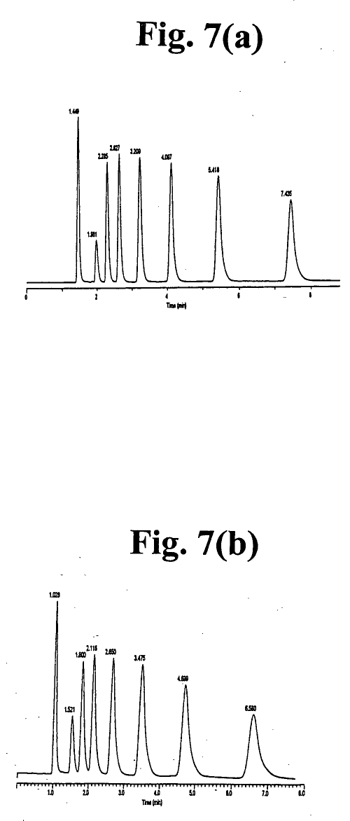

(3) With a column formed for liquid chromatography evaluation with reverse phase conditions, a octadecyldimethyl-N,N-diethylamine toluene solution (20 v %) at 80° C. was subject to surface modification by octadecylsilylation and chromatographic evaluation conducted under reverse phase conditions. See FIG. 7. FIG. 7(a) shows the results obtained with a pure silica gel produced from tetra methoxysilane while FIG. 7(b) shows results from a gel produced using BTME and EOPOEO5800. The transition phase used for evaluating was methanol-water=80/20 (v/v) and the samples used were thiourea, benzene, toluene, ethyl benzene, propyl benzene, butyl benzene, amyl benzene and hexyl benzene from the initial peak. The retention rates for the series of solutes were identical or greater than that with the pure silica column (10 nm mesopore diameters) produced from tetra methoxysilane and demonstrate similar retentions. From the results of the normal phase and reverse phase chromatography, the gel produced with BTME demonstrates sufficient separation performance as a separation medium for liquid chromatography. Also, the organic functional group bonded with a metal/carbon bond enhances the alkaline resistance of the entire gel so compared to the separation medium of the pure silica gel, the transition phase can be used within a wider range of pH.

With the present invention, it is possible to produce an organic polysilsesquioxane porous material where the pore distribution is controlled as desired. The porous material produced with the present invention also is a dual structured porous material with macropores and mesopores. Thus, in addition to applications as a column filler to pack particles in a cylinder, an application as an integrated column is also possible.

Having described the present invention, it will be apparent to one of ordinary skill in the art that many changes and modifications may be made to the above-described embodiments without departing from the spirit and the scope of the present invention.

1. A method of manufacturing an organic/inorganic hybrid porous material containing both mesopores and macropores, comprising the steps of:
a) preparing a homogenous solution where a water-soluble polymer or amphipathic material as a phase separation induction element is dissolved in an aqueous solution containing sol-gel reaction catalyst elements;
b) forming a continuous 3-dimensional mesh-structured gel comprising a solvent-rich phase, wherein a low polymer compound containing both a non-hydrolyzed organic functional group and a hydrolyzed functional group is added to said homogenous solution for a sol-gel reaction, and a skeletal phase with an organic/inorganic hybrid polymer of the low polymer compound from the sol-gel reaction affixed to the surface of the phase separation induction element comprising the water-soluble polymer or amphipathic material;
c) immersing the gel in an aqueous solution containing a compound generating ammonia via hydrolysis and curing under hydrothermal conditions by heating in a closed state,
d) forming macropores by drying the gel and evaporating the solvent from the solvent rich phase; and
e) forming mesopores in the skeletal phase by removing the phase separation induction elements from the gel after drying via thermolysis or extraction.

2. The method of claim 1, wherein the low polymer compound is a material not containing more than 50% silica.

3. The method of claim 1, wherein the organic/inorganic hybrid polymer comprises an organic polysilsesquioxane polymer.

4. The method of claim 1, wherein the sol-gel reaction process (ii) is conducted under acidic conditions for at least the initial reaction, and the sol-gel reaction involves an amount of water containing the catalyst elements that is in the range of 1.0 g˜50.0 g per 1.0 g of silica (as reduced silica anhydride weight).

5. The method of claim 1, wherein the low molecular weight polymer compound is a silicon alkoxide low molecular weight polymer compound made of units of methyl trimethoxysilane, ethyl trimethoxysilane, vinyl trimethoxysilane, δ-amino propyl triemethoxysilane, β-(3,4 epoxycyclohexyl)ethyl trimethoxysilane, N-β (aminoethyl) δ-amino propyl triethoxysilane, N-β (aminoethyl) δ-amino propyl trimethoxysilane, 3-acryloxy propyl trimethoxy-silane with the polymer having at least one silicon-carbon bond.

6. The method of claim 1, wherein the low molecular weight polymer compound is a silicon alkoxide low molecular weight polymer made of units of a bis-trialkoxy xylylalkane with the polymer having at least one carbon linked with at least two silicon atoms.
